(19) United States
(12) Patent Application Publication
(10) Pub. No.: US 2003/0100373 A1
(43) Pub. Date: May 29, 2003

(54) Game machine door locking apparatus control system

(75) Inventors: Jun Fujimoto, Tokyo (JP); Nobuyuki Nonaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 10/303,785

(22) Filed: Nov. 26, 2002

(30) Foreign Application Priority Data
Nov. 28, 2001 (JP) 2001-362407

(51) Int. Cl. A63F 9/24; A63F 13/00; G06F 17/00; G06F 19/00

(52) U.S. Cl. 463/42

(57) ABSTRACT

A game machine door locking apparatus control system 1 of this invention controls opening/closing log 94 of a door 61 of a game machine 60 and a confirmation result 95 indicating whether the door 61 of the game machine 60 is opened/closed for every game machine door locking apparatus 20 in order to specify the game machine 60 whose door 61 is opened/closed improperly. The game machine door locking apparatus control system for controlling the game machine door locking apparatus 20 provided on the door 61 of the game machine 60 comprises: a detecting unit 23 for detecting opening/closing of the door 61, a confirming unit 10 for confirming whether the door 61 is opened/closed by an administrator who has a privilege of opening/closing the door 61, a log information storage 26 provided in the game machine door locking apparatus 20 for storing the log information 90 which includes opening/closing log 94 of the door 61 detected by the detecting unit 23, a confirmation result 95 indicating whether the door 61 is opened/closed by the administrator and a device ID 92 uniquely identifying the game machine door locking apparatus 20, and a first log information manager 40 for collecting and controlling the log information 90 of game machine door locking apparatuses 20.

### CROSS REFERENCE TO RELATED APPLICATIONS

This application is based upon and claims the benefit of priority from the prior Japanese Patent Applications No. 2001-362407, filed on Nov. 28, 2001; the entire contents of which are incorporated herein by reference.

### BACKGROUND OF THE INVENTION

1. Field of the Invention

The present invention relates to a game machine door locking apparatus control system.

2. Description of the Related Art

A player can exchange pachinko balls used in pachinko machines or coins used in slot machines with gifts at a game center provided with game machines (which are including pachinko machines and slot machines) and further exchange those gifts for money. The pachinko balls can be obtained as a result of playing the pachinko and the coins can be obtained as a result of playing the slot. Some players try to obtain such pachinko balls or coins through an illegal act. The illegal act mentioned here is, for example, attaching an illegal ROM (which stores an illegally modified game machine program). The illegal ROM can be attached when the door of the game machine is opened.

For this reason, the door of the game machine is provided with a locking apparatus (for example, a cylinder key) in order to prevent improper opening/closing of that door.

Alternatively, an administrator of the game center can intensify the security against the improper opening/closing of the game machine door by providing an electronic lock locked/unlocked electrically. In the meantime, the electronic locks can be, for example, a personal identification number type, card type, and finger print verification type.

However, game machines which are provided with simply structured conventional locking apparatus, allow easy and improper opening/closing of its door.

Further, the electronic lock which cannot leave an opening and closing log indicating who locked or unlocked the electronic lock, allows improper locking/unlocking to be done by the administrator himself. The administrator is an employee of the game center who has a privilege of locking/unlocking the electronic lock. It is not desirable to provide the game machine door with the electronic lock which is generally expensive.

### BRIEF SUMMARY OF THE INVENTION

The present invention has been made in views of the above problems and has an object of providing a game machine door locking apparatus control system which enables the identification of a game machine whose door is improperly opened/closed by controlling the opening/closing log of the game machine doors and providing a confirmation result indicating whether the game machine door was opened/closed by the administrator.

According to a first aspect of the present invention, there is provided a game machine door locking apparatus control system for controlling a game machine door locking apparatus provided on the door of a game machine, comprising: a detecting unit for detecting opening/closing of the game machine door; a confirming unit for confirming whether the door of the game machine was opened/closed by an administrator who has a privilege of opening/closing the door of the game machine; a log information storage provided in the game machine door locking apparatus for storing the log information which includes the opening/closing log of the game machine door detected by the detecting unit, the confirmation result indicating whether the door of the game machine was opened/closed by the administrator and a device ID uniquely identifying the game machine door locking apparatus; and a first log information manager for collecting and controlling the log information of game machine door locking apparatuses.

According to a second aspect of the present invention, the log storage in the first aspect of invention stores log information which includes a time when the opening/closing of the game machine door was detected by the detecting unit, the opening/closing log of the game machine door, the confirmation result indicating whether the game machine door was opened/closed by the administrator and the device ID uniquely identifying the game machine door locking apparatus.

According to a third aspect of the present invention, the confirming unit in the first aspect of invention confirms whether the game machine door was opened/closed by the administrator by using an administrator code put into the confirming unit.

According to a fourth aspect of the present invention, the game machine door locking apparatus control system according to the first aspect further comprises: a battery for supplying electric power to the game machine door locking apparatus instead of a main power supply unit, when the main power supply unit stops supplying electric power to the game machine door locking apparatus control system; and a verifying unit for verifying the log information stored in the log information storage with the log information controlled by the first log information manager when the main power supply unit is restarted to supply electric power to the game machine door locking apparatus control system.

According to a fifth aspect of the present invention, the log information storage in the first aspect of invention compresses and stores the log information.

According to a sixth aspect of the present invention, the log information storage in first aspect of invention divides the log information into plural pieces and stores the plural log information pieces in plural storage spaces of the log information storage.

According to a seventh aspect of the present invention, the log information storage in the first aspect of invention stores a time when the log information stored in the log information storage is erased.

According to an eighth aspect of the present invention, the game machine door locking apparatus control system according to the first aspect further comprises a second log information manager for storing and controlling the log information controlled by the first log information manager and functions as a substitute for the first log information manager.

### BRIEF DESCRIPTION OF THE SEVERAL VIEWS OF THE DRAWINGS

FIG. 1 is a first block diagram of a game machine door locking apparatus control system 1 in this embodiment;

FIG. 2 is a block diagram of a confirming unit 10 in this embodiment;

FIG. 3 is a diagram illustrating a game machine door locking apparatus 20 in this embodiment;

FIG. 4 is a block diagram of the game machine door locking apparatus 20 in this embodiment;

FIG. 5 is a diagram of log information 90 in this embodiment;

FIG. 6 is a schematic diagram of a game center 2 in this embodiment;

FIG. 7 is a first flow chart of an operation of the game machine door locking apparatus control system 1 in this embodiment;

FIG. 8 is a flow chart of the operation of erasing the log information 90 in this embodiment;

FIG. 9 is a second flow chart of the operation of the game machine door locking apparatus control system 1 in this embodiment;

FIG. 10 is a third flow chart of the operation of the game machine door locking apparatus control system 1 in this embodiment; and

FIG. 11 is a second block diagram of the game machine door locking apparatus control system 1 in a modification.

### DETAILED DESCRIPTION OF THE INVENTION

Configuration of Game Machine Door Locking Apparatus Control System

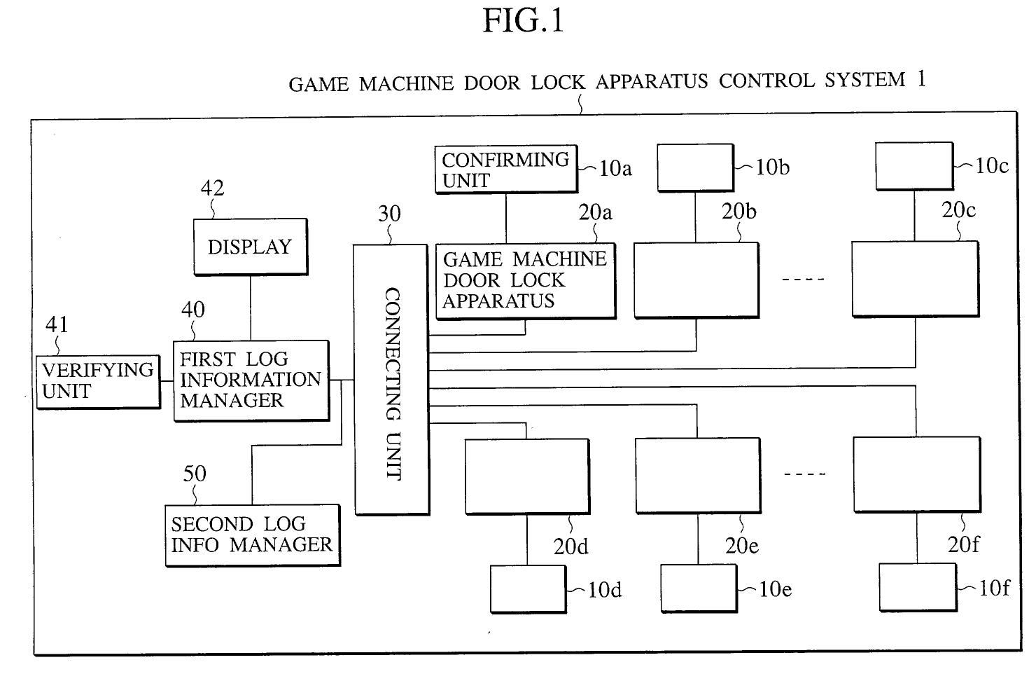

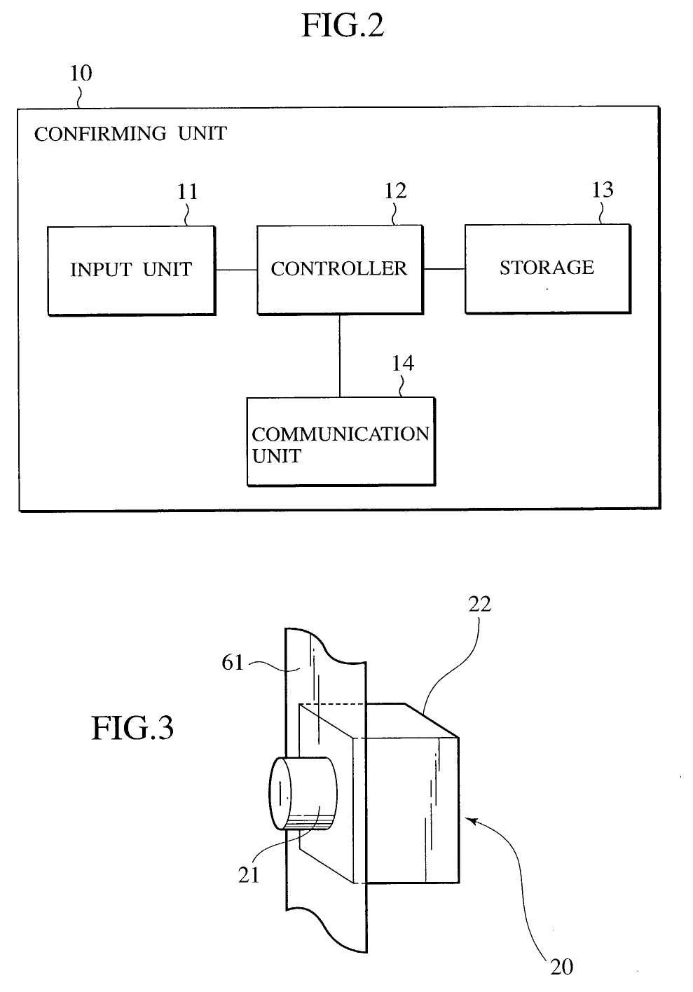

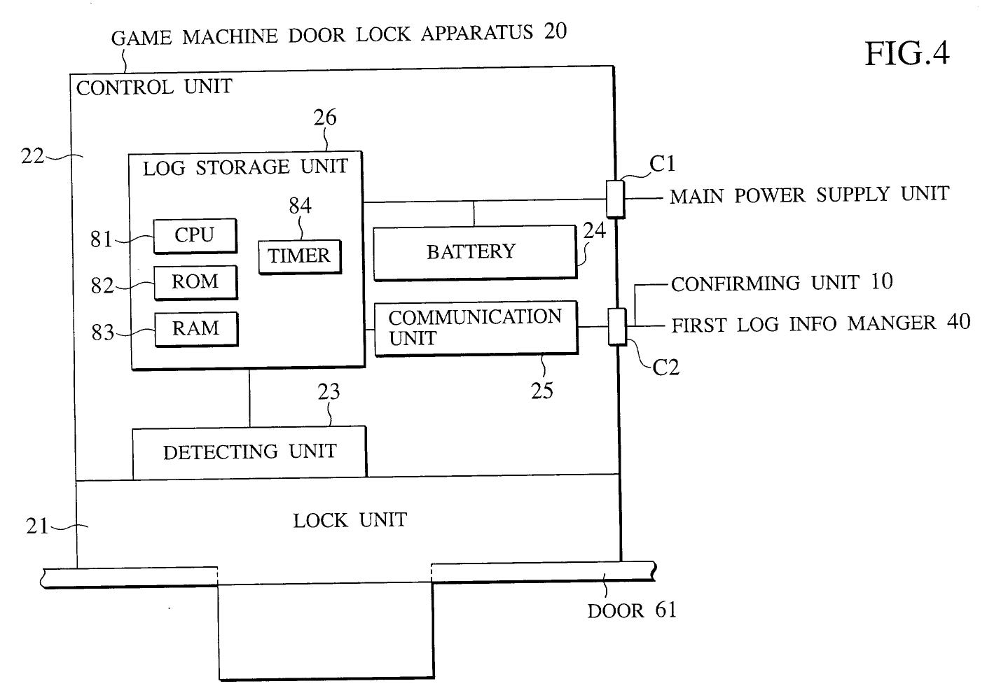

The embodiments of the present invention will be described with reference to the accompanying drawings. FIG. 1 is a block diagram of the game machine door locking apparatus control system 1 in this embodiment. FIG. 2 is a block diagram of the confirming unit 10 in this embodiment. FIG. 3 is a diagram illustrating the game machine door locking apparatus 20 in this embodiment. FIG. 4 is a block diagram of the game machine door locking apparatus 20 in this embodiment.

As shown in FIG. 1, the game machine door locking apparatus control system 1 comprises confirming units (10a to 10f), game machine door locking apparatuses (20a to 20f), a connecting unit 30, a first log information manager 40, a verifying unit 41, a display 42 and a second log information manager 50.

The confirming unit 10 confirms whether a door 61 of a game machine was opened/closed by an administrator according to an administrator code put into the confirming units 10. Further, the confirming unit 10 transmits a confirmation result indicating whether the door 61 was opened/closed by the administrator to the game machine door locking apparatus 20.

The administrator mentioned here has a privilege of opening/closing the door 61 of the game machine (for example, employees of a game center). The administrator code mentioned here identifies the administrator (for example, employee code, personal identification number). Every administrator has an administrator code.

More specifically, the confirming unit 10 comprises an input unit 11, a controller 12, storage 13 and a communication unit 14.

The input unit 11 transmits an administrator code to the controller 12. The input unit 11 mentioned here is a keyboard, a ten keys, etc.

The controller 12 verifies an administrator code received from the input unit 11 with an administrator code stored in the storage 13. If the result of this verification agrees, the controller 12 transmits the confirmation result includes an agreement signal to the game machine door locking apparatus 20. The agreement signal indicates that the door 61 was opened/closed by the administrator. If the result of verification disagrees, the controller 12 transmits the confirmation result includes a disagreement signal to the game machine door locking apparatus 20. The disagreement signal indicates that the door 61 was opened/closed by someone other than the administrator.

The storage 13 stores administrator codes identifying administrators. The storage 13 is, for example, a semiconductor memory, HDD.

The communication unit 14 provides communication between the controller 12 and the game machine door locking apparatus 20 using RS485 etc. Regarding RS485, the controller 12 and the game machine door locking apparatus 20 are connected with a pair of wires.

The game machine door locking apparatus 20 is provided on the game machine door. It is preferred that the shape of the game machine door locking apparatus 20 allows it to replace with a conventional locking apparatus (for example, a cylinder lock).

As shown in FIG. 3, the game machine door locking apparatus 20 comprises a locking unit 21 and a control unit 22. It is preferable that resin molding forms the locking unit 21 and the control unit 22 integrally.

The locking unit 21 restricts the door 61 from opening when it is locked. Additionally, the locking unit 21 permits the door 61 to open when it is unlocked. The locking unit 21 is a cylinder lock, an electronic lock etc.

As shown in FIG. 4, the control unit 22 comprises a detecting unit 23, a battery 24, a communication unit 25 and a log information storage 26.

The detecting unit 23 detects the opening/closing of the door 61 of the game machine. The detecting unit 23 transmits an opening/closing log of the door 61 to the log information storage 26. The detecting unit 23 can detect the locking/unlocking of the locking unit 21.

The detecting unit 23 can be provided to any part of the game machine except the game machine door locking apparatus 20. The detecting unit 23 can communicate with the log information storage 26 using a short-range radio communication. The short-range radio communication is, for example, bluetooth (registered trade mark), IrDA, contactless IC tag.

The detecting unit 23 can be provided with an impact sensor for detecting an unusual impact to the door 61 of the game machine. If the impact sensor detects an unusual impact, the detecting unit 23 transmits a problem signal to the log information storage 26 with the opening/closing log of the door 61. The unusual impact is applied to the door 61 when the door 61 is opened with a force.

Even if the game machine has several doors 61, the detecting unit 23 detects the opening/closing of each door 61. Japanese Patent Application No.2000-146077 has disclosed an example of the detecting unit 23.

The battery 24 supplies electric power to the game machine door locking apparatus 20 instead of a main power supply unit if the main power supply unit stops supplying the electric power. The main power supply unit supplies electric power to the game machine door locking apparatus 20 and the game machine door locking apparatus control system 1. The battery 24 is connected to the main power supply unit through a connector C1.

The battery 24 is reusable by charging with the electric power supplied from the main power supply unit. The battery 24 is, for example, nickel-cadmium hydrogen battery, lithium-ion battery. The battery 24 can be set to a part other than the game machine door locking apparatus 20.

The capacity of the battery 24 is assumed to be longer than a period when electric power is not supplied by the main power supply unit, for example, the period when the game machines are transported from the factory to game center, the period when a game center is closed. The battery 24 has a function of an AC-DC converter.

The communication unit 25 provides communication between the confirming unit 10 and the first log information manager 40 through a connector C2 using RS485, for example.

The log information storage 26 stores log information which includes the time when the opening/closing of the door 61 of a game machine is detected, the opening/closing log of the door 61, a confirmation result indicating whether the door 61 was opened/closed by an administrator, a device ID that uniquely identifies a game machine door locking apparatus 20 and a game machine ID that uniquely identifies a game machine. The log information storage 26 transmits log information stored in the log information storage 26 to the first log information manager 40.

The log information storage 26 erases log information stored in the log information storage 26 when it receives an erase instruction from the first log information manager 40. The erase instruction is an instruction to erase part or all of log information stored in the log information storage 26. The log information storage 26 transmits an erase time to the first log information manager 40, when the log information stored in the log information storage 26 is erased.

More specifically, the log information storage 26 comprises CPU 81, ROM 82, RAM 83 and a timer 84 as shown in FIG. 4.

When the detecting unit 23 receives the opening/closing log of the door 61, the CPU 81 stores log information which includes the time received from the timer, the confirmation result received from the confirming unit 10, the opening/closing log received from the detecting unit 23, the device ID uniquely identifying the game machine door locking apparatus 20 and the game machine ID uniquely identifying a game machine on the RAM 83.

The CPU 81 compresses the log information and stores the compressed log information on the RAM 83. The CPU 81 can encode or encrypt log information and store the encoded or encrypted log information on the RAM 83.

The CPU 81 divides the log information 90 into plural pieces and stores those log information pieces on plural storage spaces of the RAM 83. The CPU 81 stores the address of each of the storage spaces on ROM 82 (so-called interleaving).

The CPU 81 transmits the log information 90 stored on the RAM 83 to the first log information manager 40. When an erase instruction is received from the first log information manager 40, the CPU 81 receives a time from the timer 84 and transmits the time as the erase time to the first log information manager 40. The erase instruction is an instruction to erase part or all of the log information stored in the RAM 83. The CPU 81 stores the time on the RAM 84 when it is received from the timer. Further, the CPU 81 erases the log information stored in the RAM 83 based on the erase instruction received from the first log information manager 40.

The ROM 82 stores a program given to CPU 81. The ROM 82 stores the address of each memory region in the RAM 83 which stores the divided log information. The ROM 82 is capable of storing or erasing data (for example, EEPROM). The ROM 82 can include the function of the RAM 83.

The RAM 83 stores the log information. The RAM 83 is a nonvolatile memory (for example, MRAM, FeRAM).

The timer 84 counts time. The timer 84 transmits time counted to the CPU81 depending on a request of the CPU 81. Time counted by the timer 84 includes, for example, days, hours, minutes, and seconds. Further, the log information storage 26 can be realized on a semiconductor chip.

The connecting unit 30 connects the plural of game machine door locking apparatus 20 and the first log information manager 40 as shown in FIG. 1. The plural of game machine door locking apparatus 20 can be connected directly to the first log information manager 40 without the connecting unit 30. The connection between the plural of game machine door locking apparatus 20 and the connecting unit 30 is, for example, a star network or a ring network.

The first log information manager 40 collects and controls the log information pieces stored in the log information storage 26.

More specifically, the first log information manager 40 collects and controls the log information pieces received from the log information storage 26. The first log information manager 40 transmits an erase instruction which instructs the erasing of the stored log information to the log information storage 26. The first log information manager 40 prints out the log information collected by the first log information manager 40. The first log information manager 40 displays the log information collected by the first log information manager 40 on the display 42.

The first log information manager 40 displays an erase time received from the log information storage 26 on the display 42. Further, the first log information manager 40 displays an investigation signal received from the verifying unit 41 on the display 42. The investigation signal indicates the door 61 is opened/closed when the main power supply unit stops supplying electric power. The erase time indicates a time when the log information stored in the log information storage 26 is erased.

The first log information manager 40 can compress and store the log information pieces collected by the first log information manager 40. Further, the first log information manager 40 can divide the compressed log information and store the divided log information into each of plural storage spaces of the first log information manager 40. The first log information manager 40 can extend the log information compressed by the log information storage 26.

When the supply of electric power to the game machine door locking apparatus control system 1 is restarted by the main power supply unit, the verifying unit 41 verifies log information 90 stored in the log information storage 26 with log information 90 controlled by the first log information manager 40.

For example, the log information 90 stored in the log information storage 26 is the log information 90 at the time opening the game center and the log information 90 controlled by the first log information manager 40 is the log information 90 at the time of closing the game center the day before.

The verifying unit 41 specifies a game machine having disagreeing log information based on the result of verification. The game machine having disagreeing log information is the game machine whose door 61 was opened/closed while the supply of electric power by the main power supply unit was stopping. The verifying unit 41 transmits the investigation signal indicating the game machine specified by the verifying unit 41 to the first log information manager 40.

The display 42 displays log information controlled by the first log information manager 40. The display 42 can display the log information controlled by the first log information manager 40 for each game machine door locking apparatus 20.

The display 42 displays an erase time and an investigation signal. The erase time is a time when part or all of the log information stored in the log information storage 26 was erased.

The second log information manager 50 stores and controls log information controlled by the first log information manager 40. The second log information manager 50 functions as a reserve for the first log information manager. In the meantime, the second log information manager 50 can be controlled by a third party agency.

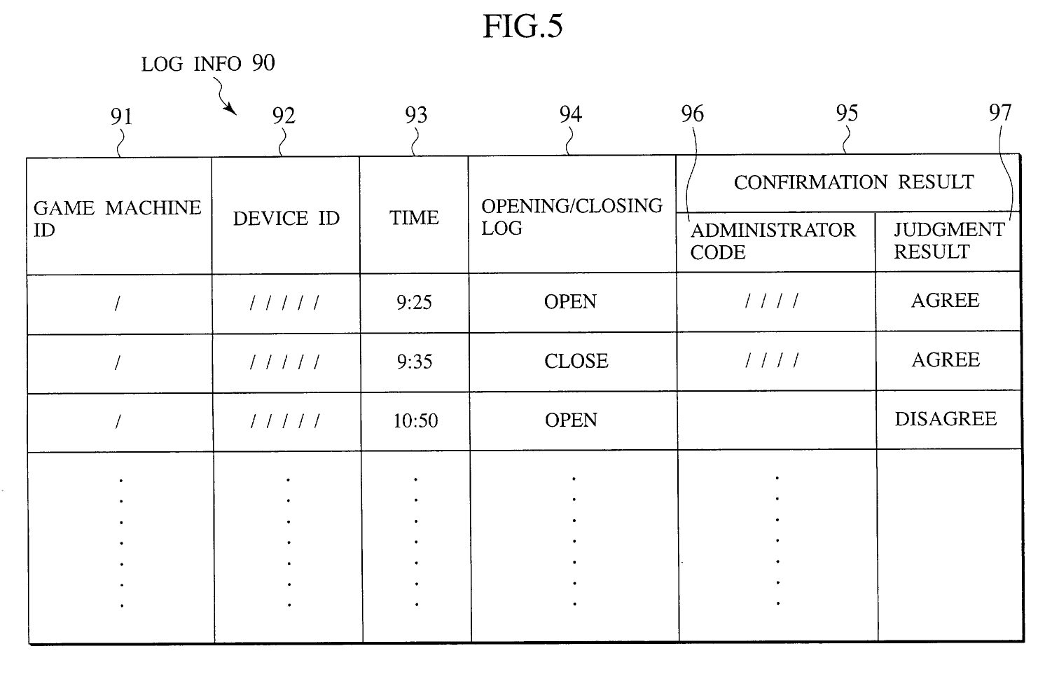

FIG. 5 is a diagram of the log information controlled by the first log information manager 40. The log information 90 is stored in the log information storage 26. The log information 90 can be sorted into each game machine door locking apparatus 20.

As shown in FIG. 5, more specifically, the log information 90 includes a game machine ID 91, a device ID 92, a time ID 93, an opening/closing log 94 and a confirmation result 95

The game machine ID 91 uniquely identifies a game machine.

The device ID 92 uniquely identifies a game machine door locking apparatus 20. In the meantime, the device ID 92 can be set by dipswitch, for example.

The time 93 is a time when the opening/closing of the door 61 is detected by the detecting unit 23.

The opening/closing log 94 indicates an opening/closing log of the door 61 of a game machine, as received from the detecting unit 23. If the detecting unit 23 detects the locking or unlocking of the locking unit 21, the opening/closing log 94 can indicate locking/unlocking of the locking unit 21.

The confirmation result 95 indicates whether the door 61 of the game machine was opened/closed by the administrator. More specifically, the confirmation result 95 is composed of an administrator code 96 and a judgment result 97. The administrator code 96 identifies the administrator (for example, an employee). The administrator code 96 is, for example, an employee code, a personal identification number. The judgment result 97 indicates whether an administrator code put into the confirming unit 10 is a proper code. More specifically, the judgment result 97 is an agreement signal or a disagreement signal received from the controller 12.

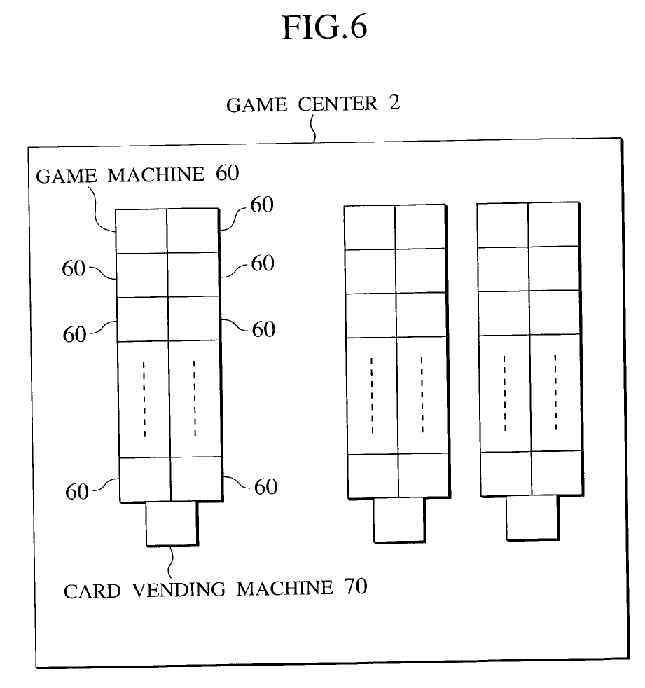

FIG. 6 is a schematic diagram of the game center 2. As shown in FIG. 6, plural of game machines 60 and plural of card vending machines 70 are provided in the game center 2.

The game machine 60 is provided with the game machine door locking apparatus 20. The game machine 60 is, for example, a pachinko machine, a slot machine.

The card vending machine 70 is a machine selling prepaid cards, for example. A prepaid card is a card for buying pachinko balls using for the pachinko or coins using for slot. The card vending machine 70 has the game machine door locking apparatus 20.

The game machine door locking apparatus 20 can be provided on a pachinko balls/coins vending machine. The pachinko balls/coins vending machine is provided between a game machine 60 and another game machine 60 in order to rent out the pachinko balls or coins to a player.

The game machine 60 can be provided with an alarm device which makes a buzzing sound, when the door 61 of a game machine 60 is opened/closed by someone other than an administrator.

Operation of Game Machine Door Locking Apparatus Control System

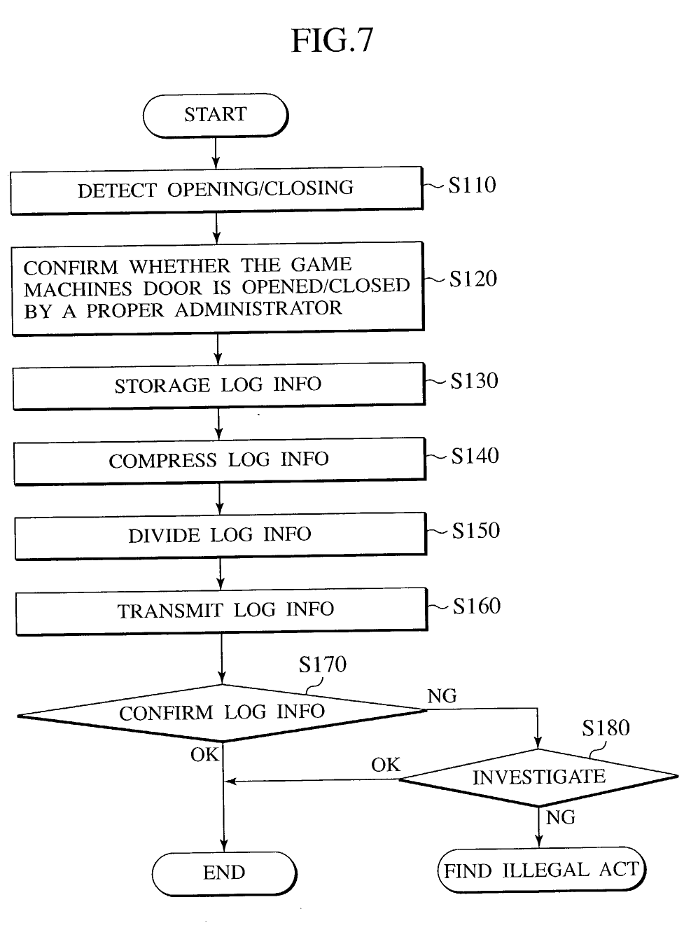

The game machine door locking apparatus control system 1 of the above configuration can be implemented by means of the following steps. FIG. 7 is a flow chart of the operation of the game machine door locking apparatus control system 1. As shown in FIG. 7, the operation of the game machine door locking apparatus control system 1 is performed in the following steps.

In step 110, detecting unit 23 detects the opening/closing of the door 61 of a game machine 61 provided with the game machine door locking apparatus 20. More specifically, the detecting unit 23 transmits the opening/closing log 94 of the door 61 to the log information storage 26.

In step 120, the confirming unit 10 confirms whether the door 61 of the game machine 60 was opened/closed by the administrator. The administrator mentioned here is an employee of a game center 2, for example.

More specifically, the controller 12 verifies an administrator code put into the input unit 11 with each of administrator codes stored in the storage 13. The controller 12 transmits a configuration result including an agreement signal to the log information storage 26 if the verification result agrees. The agreement signal indicates that the door 61 of the game machine 60 was opened/closed by the administrator.

The controller 12 transmits the configuration result including a disagreement signal to the log information storage 26 if the verification result disagrees. The disagreement signal indicates that the door 61 of the game machine 60 was opened/closed by someone except for an administrator.

In step 130, the log information storage 26 stores the log information 90 which includes the time 93 when opening/closing of the door 61 of the game machine 60 is detected by a detecting unit 23, the opening/closing log 94 of the door 61, the confirmation result 95 indicating whether the door 61 of the game machine 60 was opened/closed by the administrator, the device ID 92 uniquely identifying the game machine and the game machine ID 91 uniquely identifying the game machine.

More specifically, when the opening/closing log of the door 61 of the game machine 60 received from the detecting unit 23, the CPU 81 stores the log information 90 on the RAM 83 which information includes the time 93 received from the timer 84, the confirmation result 95 received from the confirming unit 10, the opening/closing log 94 received from the detecting unit 23, the device ID 92 uniquely identifying the game machine door locking apparatus 20 and the game machine ID 91 uniquely identifying the game machine 60.

In step 140, the log information storage 26 compresses and stores the log information 90. The log information storage 26 can encode or encrypt and store the log information 90. The log information 90 is stored in the log information storage 26.

More specifically, the CPU 81 compresses the log information 90 and stores the compressed log information 90 on the RAM 83. The CPU 81 can encode or encrypt the log information 90 and store the encoded or encrypted log information 90 on the RAM 83.

In step 150, the log information storage 26 divides the compressed log information 90 into plural pieces and stores the compressed and divided log information 90 in plural storage spaces of the log information storage 26.

More specifically, the CPU 81 divides the log information 90 to plural pieces and stores the divided log information 90 in plural storage spaces of the RAM 83. The CPU 81 stores an address indicating the storage spaces of the RAM 83 on ROM 82 (so-called interleaving).

In step 160, the log information storage 26 transmits the log information 90 stored in the log information storage 26 to the first log information manager 40. In the meantime, the log information storage 26 transmits the log information 90 stored in the log information storage 26 to the first log information manager 40 on a regular cycle.

More specifically, the CPU 81 transmits the log information 90 stored on RAM 83 to the first log information manager 40.

Instep 170, the first log information manager 40 displays the log information 90 controlled by the first log information manager 40 on the display 42.

The first log information manager 40 displays a game machine 60 whose door 61 was opened/closed by someone other than an administrator based on the confirmation result 95 included in the log information 90 on the display 42.

In step 180, a manager of the game center 2 investigates whether someone other than the administrator has performed an illegal act on the game machine 60 whose door 61 was opened/closed. The illegal act mentioned here is to attach an illegal ROM (which stores a illegally modified program of the game machine 60) to the game machine 60.

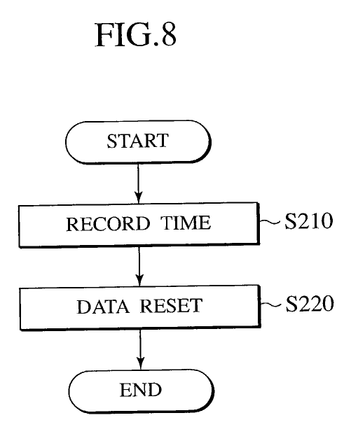

FIG. 8 is a flow chart showing the operation for erasing the log information 90 stored in the log information storage 26.

As shown in FIG. 8, in step 210, the log information storage 26 stores a time when the log information 90 stored on the log information storage 26 is erased.

More specifically, when an erase instruction is received from the first log information manager 40, the CPU 81 receives a time from the timer 84 and transmits it to the first log information manager 40. The erase instruction mentioned here is an instruction to erase part or all of the log information 90 stored on the RAM 83.

In step 220, the log information storage 26 erases the log information 90 stored on the log information storage 26 after transmitting the time to the first log information manager 40.

More specifically, the CPU 81 erases the log information 90 stored on the RAM 83 after transmitting the time to the first log information manager 40.

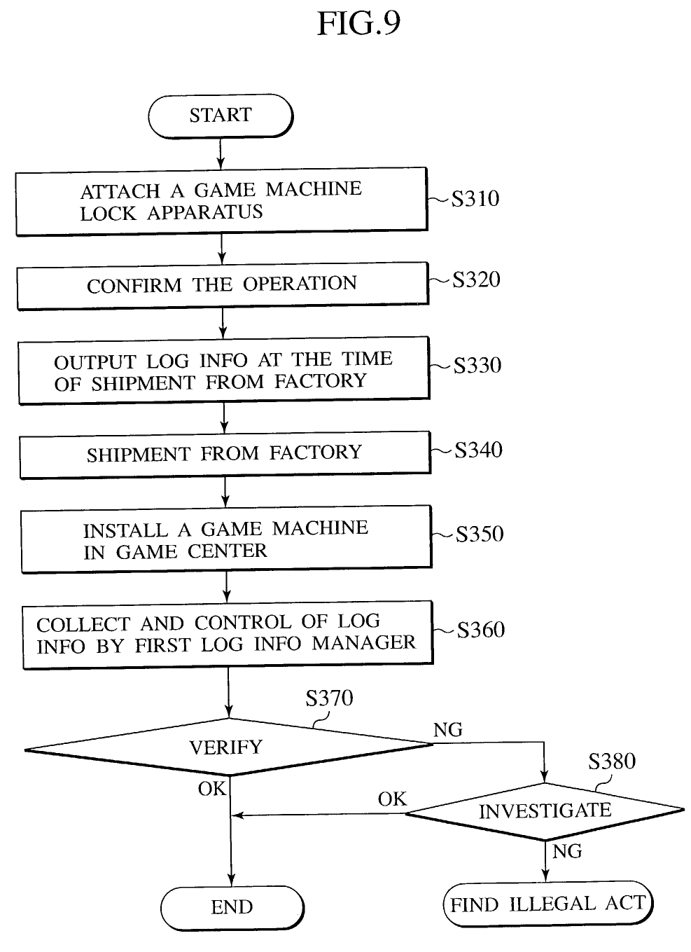

FIG. 9 is a flow chart of the operation of the game machine door locking apparatus control system 1 after the game machines are installed in the game center 2.

As shown in FIG. 9, in step 310, the game machine door locking apparatus 20 is attached to the door 61 of the game machine 60.

In step 320, operator (for example, an operator in charge of shipment) checks the operation of the game machine 60 and the game machine door locking apparatus 20. More specifically, the game machine door locking apparatus 20 is connected to a pseudo manager having a similar function to the first log information manager 40. The pseudo manager collects and controls the log information 90 stored on the log information storage 26.

In step 330, the pseudo manager prints out the log information 90 when the game machines are shipped from factory. The game machines are shipped after all the operations of the game machine 60 and the game machine door locking apparatus 20 have been checked. The pseudo manager can store the log information 90 on a portable recording medium. The portable recording medium mentioned here is a flexible disc, a memory card, etc.

In step 340, the game machine 60 with the game machine door locking apparatus 20 is transported to the game center 2. During transportation, the battery 24 supplies electric power to the game machine door locking apparatus 20. If the door 61 of the game machine 60 is opened/closed during transportation, the game machine door locking apparatus 20 stores new log information 90 on the log information storage 26.

In step 350, the game machine 60 is installed in the game center 2. More specifically, the game machine door locking apparatus 20 is connected to the first log information manager 40 and the second log information manager 50.

In step 360, the first log information manager 40 collects the log information 90 stored on the log information storage 26. The log information storage 26 is provided on the game machine door locking apparatus 20 connected to the first log information manager 40.

The first log information manager 40 prints out the log information 90 collected by the first log information manager 40. The first log information manager 40 displays the collected log information 90 on the display 42.

In step 370, the administrator of the game center 2 verifies the log information 90 at the time of shipment with the log information 90 after the game machine is installed in the game center 2. The administrator specifies a game machine 60 whose door 61 was opened/closed during transportation based on this verification. During transportation indicates an interval between the shipment from factory and installation in the game center 2.

More specifically, the administrator of the game center 2 verifies the log information 90 printed out by the pseudo manager with the log information 90 printed out by the first log information manager 40. Further, the administrator specifies a game machine 60 which has log information 90 disagrees.

The verifying unit 41 can verify the log information 90 at the time of the shipment with the log information 90 controlled by the first log information manager 40. On this occasion, it is assumed that the log information 90 at the time of the shipment is stored on a portable recording medium and the verifying unit 41 has a function of getting the log information 90 recorded in the recording medium.

In step 380, the administrator investigates whether an illegal act was performed on a game machine 60 whose door 61 was opened/closed by someone other than an administrator. The investigation is to find out if an illegal ROM (which stores an illegally modified program of the game machine) has been attached to the game machine 60.

When the investigation is finished, the first log information manager 40 can transmit an erase instruction to the game machine door locking apparatus 20, connected to the first log information manager 40.

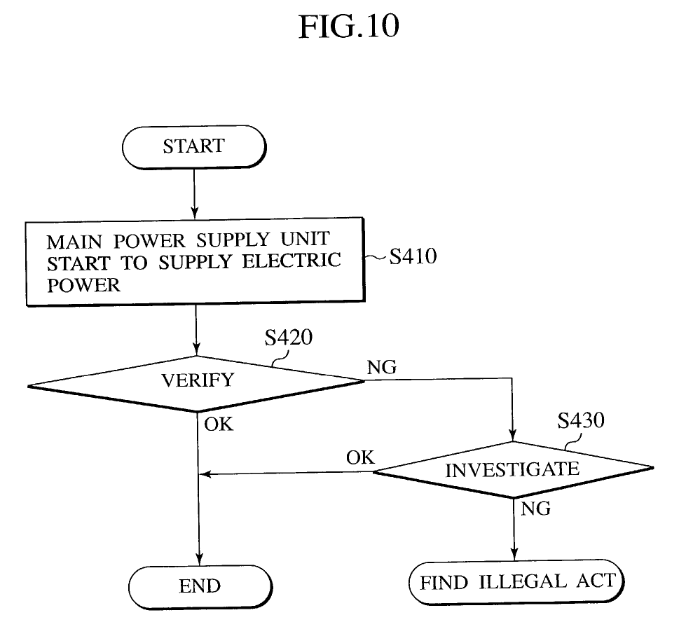

FIG. 10 is a flow chart of the operation of the game machine door locking apparatus control system 1 when the main power supply unit starts to supply electric power.

In step 410, as shown in FIG. 10, the main power supply unit starts to supply electric power to the game machine door locking apparatus control system 1. The main power supply unit starts to supply electric power when the game center 2 opens.

In step 420, the verifying unit 41 verifies the log information 90 stored on the log information storage 26 with the log information 90 controlled by the first log information manager 40.

For example, the log information 90 stored in the log information storage 26 is the log information 90 at the time of opening the game center, and the log information 90 controlled by the first log information manager 40 is the log information 90 at the time of closing the game center the day before.

The verifying unit 41 specifies a game machine 60 whose door 61 was opened/closed when the main power supply unit stops supplying electric power based on this verification.

The verifying unit 41 transmits an investigation signal indicating the game machine 60 specified by the verifying unit 41 to the first log information manager 40.

In step 430, the administrator investigates whether an illegal act (for example attaching an illegal ROM) has been performed on a game machine 60 indicated by the verifying unit 41.

Operation and Effect of the Game Machine Door Locking Apparatus Control System 1

According to the game machine door locking apparatus control system 1 on the present embodiment, the first log information manager 40 can collect and control the log information 90 stored on the game machine door locking apparatus 20. The first log information manager 40 displays the log information 90 on the display 42. The log information 90 includes a confirmation result 95 indicating whether the door 61 of a game machine is opened/closed by an administrator.

The administrator of a game center 2 can investigate whether an illegal act (for example, attaching an illegal ROM) has been performed on the game machine 60 whose door 61 was opened/closed by someone other than the administrator.

Further, even if the door 61 was opened/closed by an administrator himself to perform an illegal act, a proper administrator can discover the administrator who performed the illegal act according to the log information 90 controlled by the first log information manager 40.

In this embodiment, the battery 24 can supply electric power to the game machine door locking apparatus 20 when the main power supply unit stops supplying electric power to the game machine door locking apparatus control system 1, so that the verifying unit 41 can always specify a game machine 60 whose door 61 was opened/closed.

As a result, a lawful administrator can investigate whether an illegal act has been performed on a game machine 60 whose door 61 was opened/closed when the main power supply unit stopped supplying electric power.

Further, the game machine door locking apparatus control system 1 can save electric power because it does not need to always receive electric power from the main power supply unit.

In this embodiment, the locking unit 21 and the control unit 22 are formed by resin molding which comprises the game machine door locking apparatus 20 integrally. As a result, the control unit 22 cannot be improperly replaced.

In this embodiment, the game machine door locking apparatus 20 compresses and stores the log information 90. Further, the game machine door locking apparatus 20 divides the compressed log information 90 into plural pieces and stores the compressed and divided log information 90 in plural storage spaces of the game machine door locking apparatus 20.

As a result, the game machine door locking apparatus 20 can prevent the improper rewriting of the log information 90. Further, the game machine door locking apparatus 20 can reduce the storage capacity required for storing the log information 90.

In this embodiment, the game machine door locking apparatus 20 stores a time when the log information 90 is erased, so that the administrator of the game center 2 can find out if the log information 90 erased at an improper time.

In this embodiment, the second log information manager 50 stores the log information 90 controlled by the first log information manager 40.

As a result, if an error occurs in the first log information manager 40, the second log information manager 50 functions as a substitute of the first log information manager.

First Modification

The present invention is not limited to the above embodiment and can be modified as will be described below. The following description mentions only modified points.

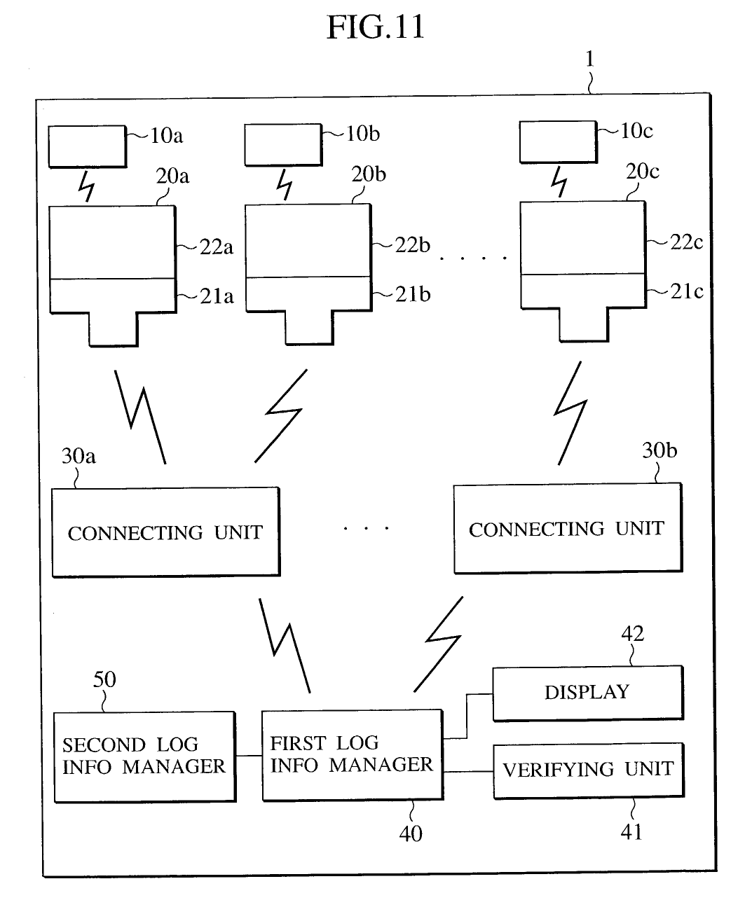

FIG. 11 is a block diagram of the game machine door locking apparatus control system 1 in this modification. As shown in FIG. 11, the game machine door locking apparatus control system 1 comprises the confirming units (10a to 10c), the game machine door locking apparatuses (20a to 20c), the connecting units (30a to 30b), the first log information manager 40, the verifying unit 41, the display 42 and the second log information manager 50.

The confirming unit 10 communicates with the game machine door locking apparatus 20 by short-range radio(for example, bluetooth (registered trade mark), IrDA, contactless IC tag).

The game machine door locking apparatus 20 communicates with the connecting unit 30 by short-range radio. The connecting unit 30 communicates with the first log information manager 40 by short-range radio. The first log information manager 40 is a portable terminal.

In this embodiment, communications among the confirming unit 10, the game machine door locking apparatus 20, the connecting unit 30 and the first log information manager 40 are performed by short range radio, so that the game machine door locking apparatus control system 1 does not require wiring.

In this embodiment, the first log information manager 40 is portable, so that the administrator can confirm the opening/closing of the door 61 of the game machine 60 at any location.

As described above, the game machine door locking apparatus control system 1 of this invention controls the opening/closing log of the door of the game machine and the confirmation result indicating whether the door was opened/closed by an administrator, it is possible to find out a game machine whose door was opened/closed improperly.

Although the present invention has been described in detail above with respect to the embodiment, it would be clear to those skilled in the art that the present invention is not limited to the embodiment described in this specification. The system of the present invention can be modified or changed for implementation without deviating from the spirit and scope of the present invention as defined in the appended claims. The description is not intended to limit the present invention but for explanatory purposes.

What is claimed is:

1. A game machine door locking apparatus control system for controlling the game machine door locking apparatus provided on the door of a game machine, comprising:
a detecting unit for detecting opening/closing of the door of the game machine;
a confirming unit for confirming whether the door of the game machine was opened/closed by an administrator who has the privilege of opening/closing the door of the game machine;
a log information storage provided on the game machine door locking apparatus for storing the log information which includes the opening/closing log of the door of the game machine detected by the detecting unit, the confirmation result indicating whether the door of the game machine was opened/closed by the administrator and a device ID uniquely identifying the game machine door locking apparatus; and
a first log information manager for collecting and controlling log information about game machine door locking apparatuses.

2. A game machine door locking apparatus control system as set forth in claim 1, wherein said log information storage stores said log information which includes a time when opening/closing of the door of the game machine is detected by said detecting unit, said opening/closing log of a door of a game machine, said confirmation result indicating whether a door of a game machine was opened/closed by the administrator and said device ID uniquely identifying said game machine door locking apparatus.

3. A game machine door locking apparatus control system as set forth in claim 1, wherein said confirming unit confirms whether a door of a game machine was opened/closed by an administrator by using an administrator code put into said confirming unit.

4. A game machine door locking apparatus control system as set forth in claim 1, further comprising:
a battery supplying electric power to said game machine door locking apparatus instead of a main power supply unit, when said main power supply unit stops supplying electric power to the game machine door locking apparatus control system; and
a verifying unit verifying said log information stored in said log information storage with said log information controlled by said first log information manager, when said main power supply unit stops supplying electric power to said game machine door locking apparatus control system.

5. A game machine door locking apparatus control system as set forth in claim 2, wherein said log information storage compresses and stores said log information.

6. A game machine door locking apparatus control system as set forth in claim 2, wherein said log information storage divides said log information into plural pieces and stores said plural log information pieces divided by said log information storage in plural storage spaces of said log information storage.

7. A game machine door locking apparatus control system as set forth in claim 1, wherein said log information storage stores a time when said log information stored said log information storage is erased.

8. A game machine door locking apparatus control system as set forth in claim 1, further comprising a second log information manager which stores and controls said log information controlled by said first log information manager and functions as a substitute for said first log information manager.
